(19) United States
(12) Patent Application Publication
(10) Pub. No.: US 2022/0346519 A1
(43) Pub. Date: Nov. 3, 2022

(54) HAIR COMB WITH OIL CARTRIDGE

(71) Applicant: Princess Perdue, Bronx, NY (US)

(72) Inventor: Princess Perdue, Bronx, NY (US)

(21) Appl. No.: 17/246,846

(22) Filed: May 3, 2021

(51) Int. Cl. A45D 24/22; A45D 24/02

(52) U.S. Cl. CPC A45D 24/22; A45D 24/02

(57) ABSTRACT

A hair comb with oil cartridge comprising a comb body having a selectively removable cover, a first end opening, a plurality of teeth, and a selectively removable oil cartridge defining an oil cavity disposed within a cartridge channel and operably configured to fluidly couple with the cartridge channel and fluid transport channel which continuously spans from the cartridge channel and fluidly couples to the first end opening of the comb body.

### FIELD OF THE INVENTION

The present invention relates generally to a hair grooming device, and, more particularly, relates to a hair comb with oil cartridge.

### BACKGROUND OF THE INVENTION

Hair care professionals and general consumers alike make frequent use of various hair styling tools when creating different hairstyles. At their disposal are a number of hair combs and brushes including, by way of example, cushion brushes, detangling brushes, bristle brushes, barber combs, fine-tooth combs, pick combs, pintail combs, teasing combs, and rat tail combs. The vast majority of these hair combing tools, however, are not designed to be fluid dispensing so as to accommodate the simultaneous use and application of hair care products, e.g., hair oils, serums, creams, formulations, etc. Existing prior art which does provide for a fluid dispensing structure or function either comprises bulky attachments or dispenses the fluid through internal channels disposed within or between the individual comb teeth or brush bristles, not through the tail of the brush or comb. See, e.g., O'Connor (Texas Romec, Inc.), U.S. Pat. No. 4,585,018 (Apr. 29, 1986); Stankovic et al., U.S. Patent Application Publication No. 2004/0031499 A1 (Feb. 19, 2004); Feiner, U.S. Pat. No. 2,465,014 (Mar. 22, 1949). Additional limitations include a restricted ability (or complete inability) to selectively control and tailor how much fluid hair care product is dispensed on a surface at a time.

Therefore, a need exists to overcome the problems with the prior art as discussed above.

### SUMMARY OF THE INVENTION

The invention provides a hair comb with oil cartridge that overcomes the hereinafore-mentioned disadvantages of the heretofore-known devices and methods of this general type and that comprises a fluid retaining and dispensing structure which retains any variety of fluid hair care products therein and selectively dispenses them onto a user's scalp through the free end of the hair comb. The foregoing features enable users to save time when styling their own, or others', hair because both the hair comb and the hair care product are combined into one device and may be used interchangeably or simultaneously.

With the foregoing and other objects in view, there is provided, in accordance with the invention, a hair comb with oil cartridge comprising a comb body disposed in a longitudinal orientation, having a first end with a selectively removable cover coupled thereto, having a second end opposing the first end, having a body length separating the first and second ends, having a plurality of teeth each with a tooth first end directly coupled to the comb body, a tooth second free end opposite the tooth first end, and each disposed in a perpendicular orientation with respect to the longitudinal orientation of the comb body, defining a first end opening at the first end of the comb body, defining a cartridge channel proximal to the second end of the comb body, and defining a fluid transport channel continuously spanning from the cartridge channel and fluidly coupled to the first end opening of the comb body, the comb body having a selectively removable oil cartridge defining an oil cavity disposed within the cartridge channel and operably configured to fluidly couple with the cartridge channel and first end opening of the comb body.

In accordance with another feature, the plurality of teeth may further comprise a teeth length that is less than a cartridge length defined by the cartridge channel.

In accordance with a further feature of one embodiment of the present invention, the first end opening at the first end of the comb body is enclosed.

In accordance with a further feature of another embodiment of the present invention, the selectively removable oil cartridge further comprises a cartridge first end disposed proximal to the second end of the comb body and a cartridge second end opposing the cartridge first end, the cartridge second end directly and engagedly coupled to an inner surface of the comb defining the fluid transport channel.

In accordance with another feature, an embodiment of the present invention also includes a selectively removable cap disposed of at the second end of the comb body and coupled to the cartridge first end in a watertight configuration. In an alternate embodiment, the selectively removable cap is coupled to the cartridge first end in a watertight configuration and has a flange coupled to the second end of the comb body in flush configuration.

In accordance with yet another feature, an embodiment of the present invention includes a second end opening defined at the second end of the comb body, the cartridge channel spanning from the second end opening to the fluid transport channel.

In accordance with a further feature of one embodiment of the present invention, the selectively removable oil cartridge is operably configured to be selectively and slidably inserted into the cartridge channel through the second end opening in a longitudinal orientation.

In accordance with yet another feature of one embodiment of the present invention, the comb body further comprises a sidewall surrounding and defining the cartridge channel, the sidewall defining a viewing aperture fluidly coupled to the cartridge channel, the selectively removable oil cartridge of a transparent material.

Although the invention is illustrated and described herein as embodied in a hair comb with oil cartridge, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the comb, spanning from the first end of the comb to the second end of the comb. The term “traverse” should be understood to mean in a direction corresponding to a direction spanning from one end of the bristles or teeth attached to the comb body to the second free end of the bristles or teeth.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective side view of a hair comb with oil cartridge;

FIG. 2 is a perspective side view of a hair comb with oil cartridge, in accordance with the present invention;

FIG. 3 is an elevational side view of a hair comb with oil cartridge;

FIG. 4 is an elevational side view of a hair comb with oil cartridge;

FIG. 5 is an elevational side view of a hair comb with oil cartridge;

FIG. 6 is an elevational bottom view of hair comb with oil cartridge, in accordance with an exemplary embodiment of the present invention;

FIG. 7 is an elevational top view of another exemplary embodiment of a hair comb with oil cartridge, in accordance with the present invention;

FIG. 8 is an elevational top view of a further exemplary embodiment of a hair comb with oil cartridge, in accordance with the present invention;

FIG. 9 is an elevational bottom view of yet another exemplary embodiment of a hair comb with oil cartridge, in accordance with the present invention;

FIG. 10 is an elevational side view of one exemplary embodiment of a hair comb with oil cartridge;

FIG. 11 is a perspective side view of an upright hair comb with oil cartridge, in accordance with the present invention; and

FIG. 12 is an exploded view of an exemplary hair comb with oil cartridge, in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

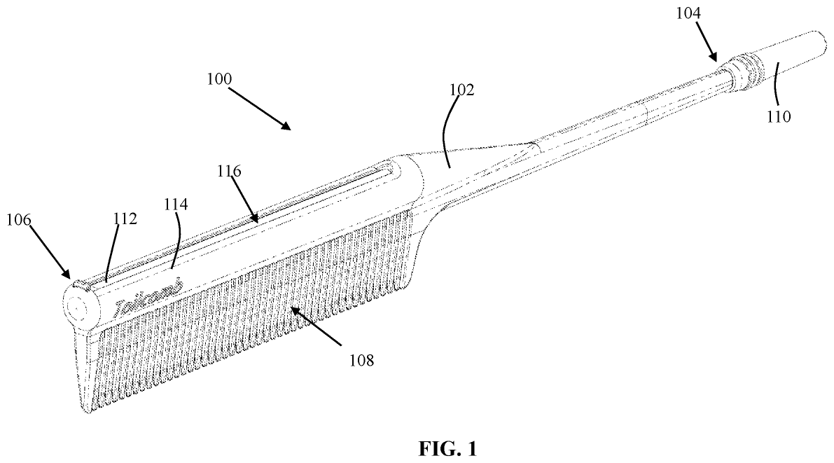

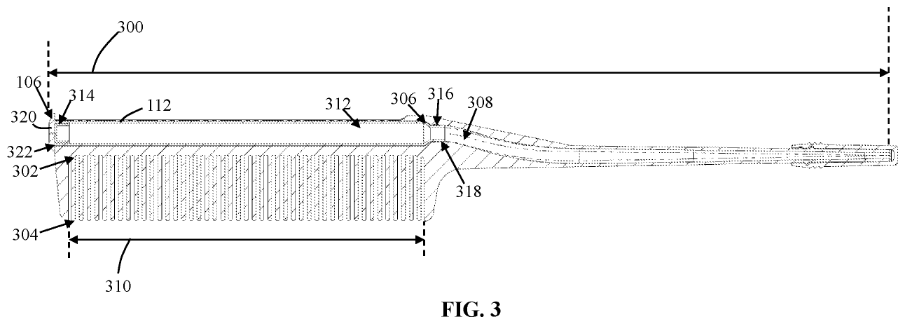

The present invention provides a novel and efficient hair comb with oil cartridge (hereinafter referred to simply as “hair comb” for brevity). Referring now to FIG. 1, one embodiment of the present invention is shown in a perspective side view. FIG. 1 shows several advantageous features of the present invention, but, as will be described below, the invention can be provided in several shapes, sizes, combinations of features and components, and varying numbers and functions of the components. The first example of a hair comb 100, as shown in FIG. 1, includes a comb body 102 disposed in a longitudinal orientation of the hair comb 100 and having a first end 104 with a selectively removable cover 110 coupled thereto, a second end 106 opposing the first end 104, and a body length 300 separating the first and second ends 104, 106. In a preferred embodiment, the selectively removable cover 110 is of a polypropylene material but may be of a variety of natural, synthetic, or semi-synthetic compositions in alternate embodiments including, without limitation, metallic, wooden, or polymeric materials. The comb body 102 is of an acrylonitrile butadiene styrene material in an exemplary embodiment but may likewise be of a variety of natural, synthetic, or semi-synthetic compositions in alternate embodiments including, without limitation, metallic, wooden, or other thermoplastic polymeric materials. As best depicted in FIG. 3, the body length 300 is the distance from the first end 104 to the second end 106 and, in a preferred embodiment, ranges between approximately 6 and 10 inches in length.

The comb body 102 further comprises a plurality of teeth 108 each with a tooth first end 302 directly coupled to the comb body 102, a tooth second free end 304 opposite the tooth first end 302, and each disposed in a perpendicular orientation with respect to the longitudinal orientation of the comb body 102, as best seen in FIG. 3, wherein “perpendicular” is defined as at an angle of 90° to a given line, plane, or surface. The tooth second free end 304, wherein “free” is defined as not directly attached to any structure, is beneficially designed to come into direct contact with a user's hair strands and/or scalp to comb and detangle a user's individual hair strands. The plurality of teeth 108 may consist of individual teeth members 108a-n, wherein “n” is any number greater than one, spatially disposed along the length of the comb body 102 at substantially equal intervals of space of one another. In different embodiments, the plurality of teeth 108 span across approximately 30% to 70% of the body length 300 of the comb body 102.

In accordance with a further feature of the present invention, the comb body 102 defines a first end opening 200 at the first end 204 of the comb body 102, defining a cartridge channel 306 proximal to the second end 106 of the comb body 102, and defining a fluid transport channel 308 continuously spanning from the cartridge channel 306 and fluidly coupled to the first end opening 200 of the comb body 102, the comb body 102 having a selectively removable oil cartridge 112 defining an oil cavity 312 disposed within the cartridge channel 306 and operably configured to fluidly couple with the cartridge channel 306 and first end opening 200 of the comb body 102. In a preferred embodiment, the selectively removable oil cartridge 112 is of a polypropylene material but may be of a variety of natural, synthetic, or semi-synthetic compositions in alternate embodiments including, without limitation, metallic or polymeric materials.

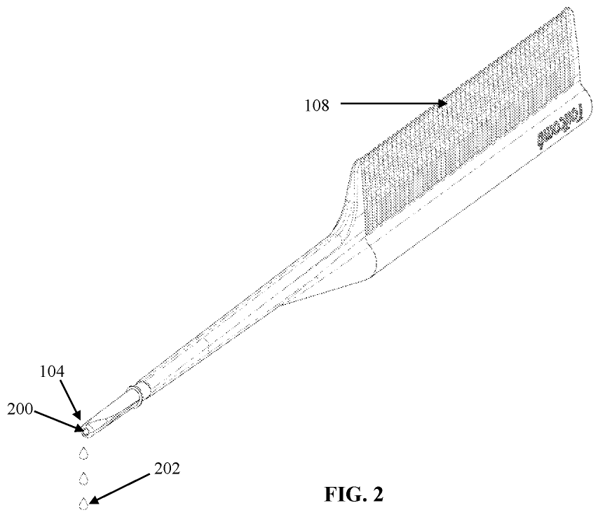

As best depicted in FIGS. 2 and 3, the first end opening 200 is configured to be of a size and shape sufficiently wide to facilitate the controlled flow of hair care fluid 202 from the fluid transport channel 308 to a surface external to the comb body 102. In exemplary embodiments, the external surface is a user's scalp or hair strands and the first end opening 200 functions as an outlet or egress for the hair care fluid 202 that is retained within the selectively removable oil cartridge 112 and fluid transport channel 308. The hair care fluid 202 consists of generally available and substantially liquid hair care products such as, by way of example and without limitation, hair care oils, serums, lotions, conditioners, solutions, and other medicinal or non-medicinal hair care formulations. As such, the first end opening 200 must be of a diameter that is wide enough to allow the hair care fluid 202 within the fluid transport channel 308 to escape but not so wide as to create an unfettered or uncontrolled flow of the hair care fluid 202 from within the fluid transport channel 308. In one embodiment, the first end opening 200 is enclosed to further limit and restrict the unfettered or uncontrolled flow of the hair care fluid 202 from within the fluid transport channel 308. In an exemplary embodiment, the first end opening 200 is approximately between 0.3 and 0.7 millimeters in diameter, though these dimensions may vary among different embodiments of the present invention. The selectively removable cover 110 is configured to be placed over the first end opening 200 when the comb body 102 is not in use to form a substantially watertight configuration and to restrict and prevent the escape of hair care fluid 202 from within the fluid transport channel 308. This allows the comb body 102 to be safely stored when not in use without the worry that the hair care fluid 202 within the fluid transport channel 308 will escape and damage the external items or contents located proximal to the comb body 102 or the storage surface on which the comb body 102 is placed. Further, the selectively removable cover 110 serves to seal the first end opening 200 and confine the hair care fluid 202 within the fluid transport channel 308 and the selectively removable oil cartridge 112 in such a way that no external agents, including, by way of example and without limitation, foreign liquids, solutions, solid particulates, or air particles, are able to enter the fluid transport channel 308. This beneficial feature helps preserve the integrity of the hair care fluid 202 housed within the fluid transport channel 308 and to protect the hair care fluid 202 from being spoiled, tainted, polluted, distilled, evaporated, dried out, or otherwise compromised in another comparable way. The selectively removable cover 110 may be attached to the comb body 102 in a variety of ways including, without limitation, a friction-fit configuration, a tongue-and-groove configuration, or a threaded configuration.

In accordance with a further feature of the present invention, the comb body 102 defines the cartridge channel 306 proximal to the second end 106 of the comb body 102, wherein “proximal” is defined as located at or near the second end 106 of the comb body 102, i.e., within 10% to 15% of the second end 106. In an exemplary embodiment, the cartridge channel 306 is of a length that ranges approximately between 30% to 60% of the body length 300 to accommodate the storage of a smaller or greater volume of hair care fluid 202 within the selectively removable oil cartridge 112, depending on the needs of the user. In an alternate embodiment of the present invention, the plurality of teeth 108 further comprise a teeth length 310 that is less than a cartridge length defined by the cartridge channel 306. In a preferred embodiment, the cartridge channel 306 is disposed directly adjacent to the plurality of teeth 108 to provide a balanced distribution of weight, ease and convenience of handling the comb body 102 as a whole, and a more compact structure and design.

The fluid transport channel 308 continously spans from the cartridge channel 306 and fluidly couples to the first end opening 200 of the comb body 102. In an exemplary embodiment, the fluid transport channel 308 is of a length that ranges approximately between 40% to 70% of the body length 300. The fluid transport channel 308 beneficially transports the hair care fluid 202 housed within the selectively removable oil cartridge 112 to the first end opening 200 where, if the selectively removable cover 110 has been removed, the hair care fluid 202 can freely exit the fluid transport channel 308 and be applied directly onto a desired surface, e.g., a user's scalp or hair.

In accordance with a further feature, the selectively removable oil cartridge 112 defines the oil cavity 312 disposed within the cartridge channel 306 and is operably configured to fluidly couple with the cartridge channel 306 and first end opening 200 of the comb body 102. In a preferred embodiment, and as best depicted in FIGS. 1 and 3, the selectively removable oil cartridge 112 comprises a cartridge first end 314 disposed proximal to the second end 106 of the comb body 102, wherein “proximal” is defined as located at or near the second end 106 of the comb body 102, i.e., within 10% to 15% of the second end 106, and a cartridge second end 316 opposing the cartridge first end 314, the cartridge second end 316 directly and engagedly coupled to an inner surface 318 of the comb body 102 defining the fluid transport channel 308. The cartridge second end 316 may be directly and engagedly coupled to the inner surface 318 of the comb body 102 by, for example and without limitation, a friction-fit configuration, a tongue-and-groove configuration, a threaded configuration, or any other comparable configuration. Each configuration allows for the selectively removable oil cartridge 112 to fluidly dispense the hair care fluid 202 therein into the fluid transport channel 308 for use and application onto a desired surface, e.g., a user's scalp or hair. In preferred embodiments, the oil cavity 312 and the cartridge channel 306 have dimensions slightly greater than the dimensions of the selectively removable oil cartridge 112 so as to create a snug fit between the selectively removable oil cartridge 112 and the oil cavity 312 and cartridge channel 306 when the selectively removable oil cartridge 112 is inserted into the oil cavity 312. A snug fit ensures that movement of the selectively removable oil cartridge 112 within the oil cavity 312 and the cartridge channel 306 is limited so that the selectively removable oil cartridge 112 remains fluidly coupled to the fluid transport channel 308 during and throughout use. This snug configuration also prevents or otherwise reduces the chances of damage or breakage occurring to any one of the foregoing components of the comb body 102.

The selectively removable oil cartridge 112 may be selectively removed and extracted from the comb body 102 for refill, replacement, cleaning, or repair. In one embodiment, the hair care fluid 202 within the selectively removable oil cartridge 112 may be refilled once internal levels of the hair care fluid 202 within the selectively removable oil cartridge 112 become low or are completely used up. In another embodiment, the selectively removable oil cartridge 112 is disposable and may be replaced with a new selectively removable oil cartridge 112 that is full of hair care fluid 202 once the hair care fluid 202 within the original selectively removable oil cartridge 112 is fully depleted. The selectively removable quality of the selectively removable oil cartridge 112 also gives users the ease and convenience of having the ability to refill the hair care fluid 202 within the selectively removable oil cartridge 112 separately and over a different surface and to then re-insert the selectively removable oil cartridge 112 in the oil cavity 312. This reduces the chances of excess hair care fluid 202 entering any of the components or crevices of the comb body 102 and damaging or deteriorating any of the components of the comb body 102.

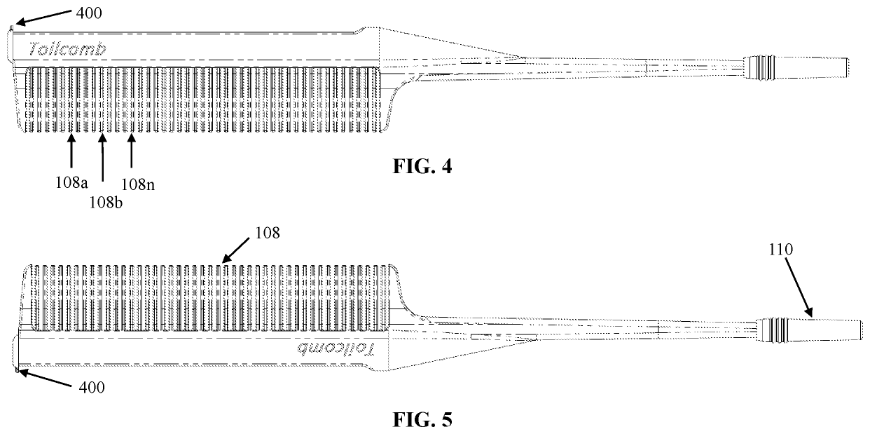

In accordance with a further feature of a preferred embodiment, the comb body 102 further comprises a second end opening 322 defined at the second end 106 of the comb body 102, the cartridge channel 306 spanning from the second end opening 322 to the fluid transport channel 308 to facilitate retention and storage of a greater volume of hair care fluid 202 therein. In an exemplary embodiment, the selectively removable oil cartridge 112 is operably configured to selectively and slidably insert into the cartridge channel 306 through the second end opening 322 in a longitudinal orientation of the comb body 102. The selectively removable oil cartridge 112 may further comprise a selectively removable cap 320 disposed at the second end 106 of the comb body 102 and coupled to the cartridge first end 314 in a watertight configuration. The selectively removable cap 320 is substantially comprised of a polysiloxane composition, generally known as silicone, or another substantially equivalent material and beneficially restricts and prevents the escape of hair care fluid 202 from within the selectively removable oil cartridge 112 through the second end opening 322. In an alternate embodiment, the selectively removable cap 320 is coupled to the cartridge first end 314 in a watertight configuration and has a flange 400 coupled to the second end 106 of the comb body 102 in flush configuration, wherein “flush configuration” is defined as being immediately adjacent or contiguous or forming the same plane. As best depicted in FIGS. 4 and 5, the flange 400 improves the ease and convenience of removing the selectively removable cap 320 because the flange 400 extends and protrudes outwardly away from the comb body 102, making it easier for a user to grasp the flange 400 and exert pressure on the flange 400 to remove the selectively removable cap 320 and expose the selectively removable oil cartridge 112 and cartridge channel 306.

In an exemplary embodiment, the comb body 102 further comprises a sidewall 114 surrounding and defining the cartridge channel 306, the sidewall 114 defining a viewing aperture 116 fluidly coupled to and spanning the length of the cartridge channel 306. The selectively removable oil cartridge 112 is preferably of a transparent material, wherein “transparent” is defined as so sheer as to permit light to pass through so that objects situated beyond or behind are distinctly visible, and translucent, i.e., permitting light to pass through but diffusing it so that objects situated beyond or behind are not clearly or distinctly visible. This transparent or translucent characteristic of the selectively removable oil cartridge 112 enables a user to readily view, through the viewing aperture 116, and ascertain the quantity or volume of hair care fluid 202 that remains within the selectively removable oil cartridge 112 so as to facilitate prompt and timely refill or replacement of the selectively removable oil cartridge 112. In preferred embodiments, the viewing aperture 116 spans the length of the cartridge channel 306 in a longitudinal orientation of the comb body 102. When the comb body 102 is placed in an upright position, this feature allows a user to accurately ascertain approximately how much hair care fluid 202 remains in the selectively removable oil cartridge 112 and determine whether a refill or replacement of the same is necessary. In an exemplary embodiment, the viewing aperture 116 is of a length that ranges approximately between 70% to 100% of the teeth length 310 to ensure the full volume capacity of the selectively removable oil cartridge 112, and the fluctuating volume level of the hair care fluid 202 therein, is readily and accurately visible. In alternate embodiments, the entirety of the sidewall 114 surrounding and defining the cartridge channel 306 is of a transparent material, as that term is defined above, thereby allowing users to readily view and ascertain the volume level of the hair care fluid 202 in the selectively removable oil cartridge 112 from any angle, instead of only being able to readily view the volume level from and through the viewing aperture 116.

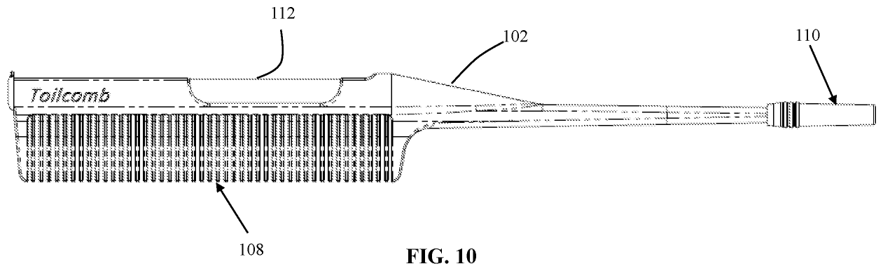

In accordance with a further feature of an alternate embodiment of the present invention, the comb body 102 further comprises a compression push button disposed on the comb body 102 along the body length 300 proximate to the second end 106 of the comb body 102, the compression push button operably configured to selectively release a desired quantity of hair care fluid 202 from the first end opening 200. This beneficial feature enables a user to selectively release a desired quantity of hair care fluid 202 from the first end opening 200 during use of the hair comb 100 without having to continuously remove and replace the selectively removable cap 320 on the first end opening 200 in between applications of the hair care fluid 202 onto a user's hair or scalp. To release the hair care fluid 202 from the first end opening 200, a user must remove the selectively removable cap 320 from the first end opening 200 and exert a pushing force onto the compression push button, e.g., approximately 2-5 lbs, which then operably releases the hair care fluid 202 from within the fluid transport channel 308. Further, the compression push button is preferably disposed on the comb body 102 along the body length 300 proximate to the second end 106 of the comb body 102 to avoid and/or prevent inadvertent pushing of the compression push button by a user. During use, a user's palm is typically placed on or around the body length 300 proximate to the first end 104 of the comb body 102. By placing the compression push button along the body length 300 proximate to the second end 106 of the comb body 102, the probability that a user may accidentally or inadvertently push down on the compression push button and release the hair care fluid 202 when the user does not intend to is substantially decreased. In one embodiment, the compression push button may be a partially exposed portion of the selectively removable oil cartridge 112 which a user may selectively squeeze or apply pressure to when the user desires to dispense the hair care fluid 202 (as best seen in FIGS. 10-12).

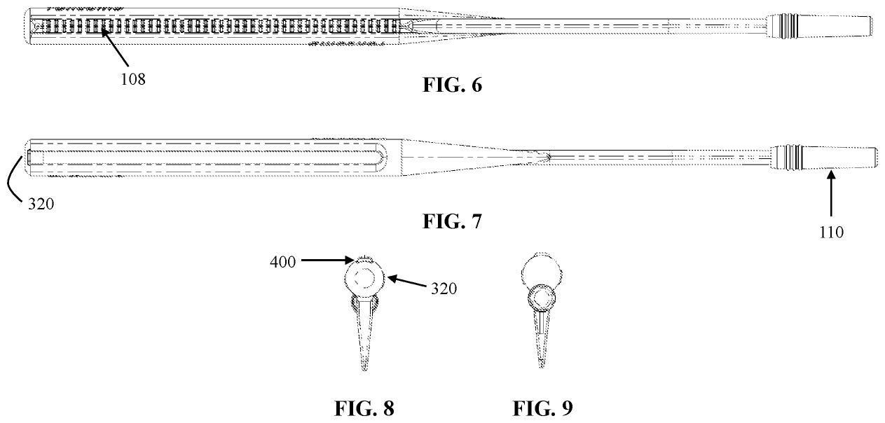

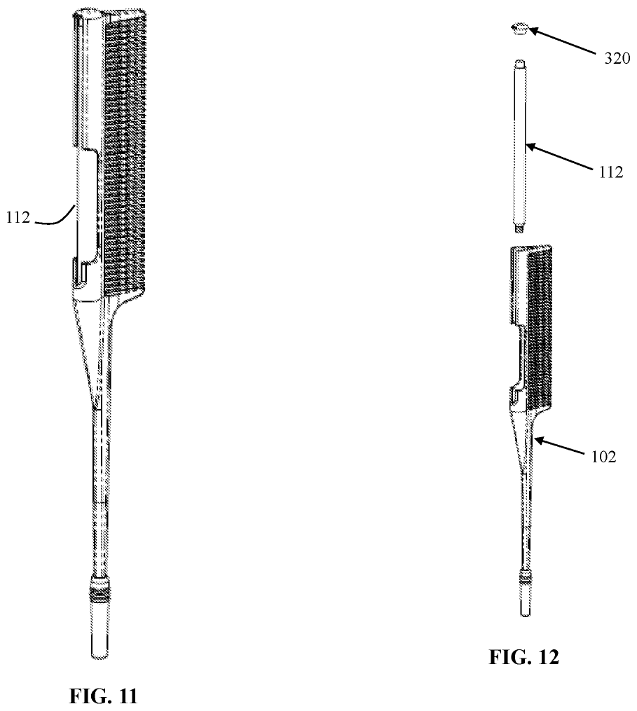

FIGS. 6-10 depict several elevational views of the comb 100, as well as the selectively removable cap 320 and flange 400. FIGS. 11-12 depict one exemplary embodiment of the present invention, wherein the comb 100 is shown in an upright position. FIG. 12 is an exploded view of the comb 100 depicting the selectively removable cap 320, the selectively removable oil cartridge 112, and the comb body 102. As best seen in FIGS. 10-12, in one embodiment of the present invention, the selectively removable oil cartridge 112 is partially exposed to allow dispensing of the hair care fluid 202 by a user by selectively squeezing, or applying pressure to, the selectively removable oil cartridge 112. The selective application of pressure to the selectively removable oil cartridge 112 by a user enables a user to beneficially and conveniently control the amount of hair care fluid 202 the user wishes to dispense during use.

Various modifications and additions can be made to the exemplary embodiments discussed herein without departing from the scope of the present disclosure. For example, while the embodiments described above refer to particular features, the scope of this disclosure also includes embodiments having different combinations of features and embodiments that do not include all of the above-described features.

What is claimed is:

1. A hair comb with oil cartridge comprising:
a comb body disposed in a longitudinal orientation, having a first end with a selectively removable cover coupled thereto, having a second end opposing the first end, having a body length separating the first and second ends, having a plurality of teeth each with a tooth first end directly coupled to the comb body, a tooth second free end opposite the tooth first end, and each disposed in a perpendicular orientation with respect to the longitudinal orientation of the comb body, defining a first end opening at the first end of the comb body, defining a cartridge channel proximal to the second end of the comb body, and defining a fluid transport channel continuously spanning from the cartridge channel and fluidly coupled to the first end opening of the comb body, the comb body having a selectively removable oil cartridge defining an oil cavity disposed within the cartridge channel and operably configured to fluidly couple with the cartridge channel and first end opening of the comb body.

2. The hair comb with oil cartridge according to claim 1, wherein the plurality of teeth further comprise:
a teeth length that is less than a cartridge length defined by the cartridge channel.

3. The hair comb with oil cartridge according to claim 1, wherein:
the first end opening is enclosed.

4. The hair comb with oil cartridge according to claim 1, wherein the selectively removable oil cartridge further comprises:
a cartridge first end disposed proximal to the second end of the comb body and a cartridge second end opposing the cartridge first end, the cartridge second end directly and engagedly coupled to an inner surface of the comb body defining the fluid transport channel.

5. The hair comb with oil cartridge according to claim 4, wherein the selectively removable oil cartridge further comprises:
a selectively removable cap disposed at the second end of the comb body and coupled to the cartridge first end in a watertight configuration.

6. The hair comb with oil cartridge according to claim 4, wherein the selectively removable oil cartridge further comprises:
a selectively removable cap coupled to the cartridge first end in a watertight configuration and having a flange coupled to the second end of the comb body in flush configuration.

7. The hair comb with oil cartridge according to claim 1, wherein the comb body further comprises:
a second end opening defined at the second end of the comb body, the cartridge channel spanning from the second end opening to the fluid transport channel.

8. The hair comb with oil cartridge according to claim 7, wherein:
the selectively removable oil cartridge is operably configured to be selectively and slidably inserted into the cartridge channel through the second end opening in a longitudinal orientation.

9. The hair comb with oil cartridge according to claim 1, wherein the comb body further comprises:
a sidewall surrounding and defining the cartridge channel, the sidewall defining a viewing aperture fluidly coupled to the cartridge channel, the selectively removable oil cartridge of a transparent material.

10. The hair comb with oil cartridge according to claim 1, wherein the comb body further comprises:
a sidewall surrounding and defining the cartridge channel, the sidewall of a transparent material.

11. The hair comb with oil cartridge according to claim 1, wherein the comb body further comprises:
a compression push button disposed on the comb body along the body length proximate to the second end of the comb body, the compression push button operably configured to selectively release a desired quantity of oil from the first end opening of the comb body.
